(19) United States
(12) Patent Application Publication
(10) Pub. No.: US 2010/0066729 A1
(43) Pub. Date: Mar. 18, 2010

(54) DIGITAL PHOTO FRAME CAPABLE OF ADJUSTING DIGITAL IMAGE AND METHOD THEREOF

(75) Inventors: XIAO-GUANG LI, Shenzhen City (CN); KUAN-HONG HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/471,338

(22) Filed: May 22, 2009

(30) Foreign Application Priority Data
Sep. 17, 2008 (CN) 200810304537.1

(51) Int. Cl. G06T 1/00

(52) U.S. Cl. 345/418

(57) ABSTRACT

A digital photo frame capable of adjusting images is provided. The digital photo frame includes a user input unit, a memory, a display, a processor. The memory is configured for storing images, original image property settings, and a predetermined algorithm, the predetermined algorithm records a rule to retrieve other settings based on an original property setting. The processor includes a reading module and a display module. The reading module is configured for obtaining images and settings of each image property from the memory. The display module is configured to retrieves other property settings according to the original property setting and the predetermined algorithm, display several instances of the same image at different retrieved settings simultaneously, and further select one of the settings as the desirable setting in response to the user input operation.

### BACKGROUND

1. Technical Field

The disclosure relates to a digital photo frame for adjusting digital images and a method employed by the digital photo frame to adjust the images.

2. Description of Related Art

Digital photo frames are intended to conveniently display images without the need to print the images out. Displaying image is an essential function of digital photo frames, therefore, how to get a better effect in displaying images will be an important selling point for attracting customers.

Traditionally, users change settings of images by adjusting values of an image property of the images, each setting is corresponding to a value of each image property. User may get a better setting, but it is difficult for user to get the best setting, because, there is no reference while user selects a setting of an image. Therefore, what is needed is a digital photo frame capable of providing references while adjusting images and method thereof.

### BRIEF DESCRIPTION OF THE DRAWINGS

The components of the drawings are not necessarily drawn to scale, the emphasis instead being placed upon clearly illustrating the principles of a digital photo frame. Moreover, in the drawings, like reference numerals designate corresponding parts throughout several views.

FIG. 1 is a block diagram of a digital photo frame in accordance with an exemplary embodiment.

FIG. 2 is a flowchart illustrating a method of adjusting properties of an image implemented by the digital photo frame of FIG. 1 in accordance with an exemplary embodiment.

FIG. 3 is a schematic diagram illustrating a user interface of the digital photo frame of FIG. 1 in a state when an image property of an image is adjusted.

FIG. 4 is a schematic diagram illustrating a user interface of the digital photo frame of FIG. 1 in a state when two properties of an image are adjusted.

### DETAILED DESCRIPTION

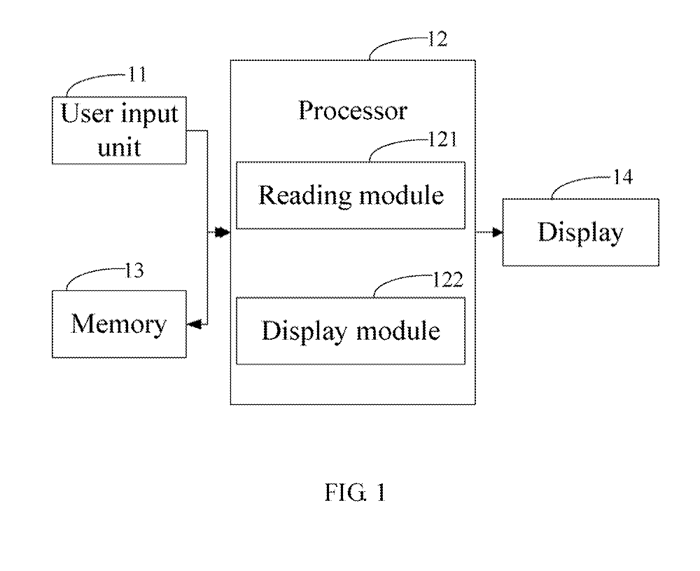

FIG. 1 is a block diagram of a hardware infrastructure of a digital photo frame 10 in accordance with an exemplary embodiment. The digital photo frame 10 includes at least one user input unit 11, a processor 12, a memory 13, and a display 14.

The memory 13 is configured for storing images. Each image is associated with a plurality of image properties, such as brightness, contrast, display angle, and the like. The memory 13 further stores different original property settings of the image, and a predetermined algorithm, wherein the predetermined algorithm records a rule to retrieve other settings based on an corresponding original property setting. In the exemplary embodiment, if S0 represents an original property value, then other settings as determined by the algorithm will be: S0+/−S0*10%, and S0+/−S0*20%, if the corresponding original contrast setting is 50%, accordingly, contrast settings of 40%, 45%, 55%, and 60% are retrieved. Additionally, the memory 13 also stores a predetermined sequence, which records an order of properties to be adjusted.

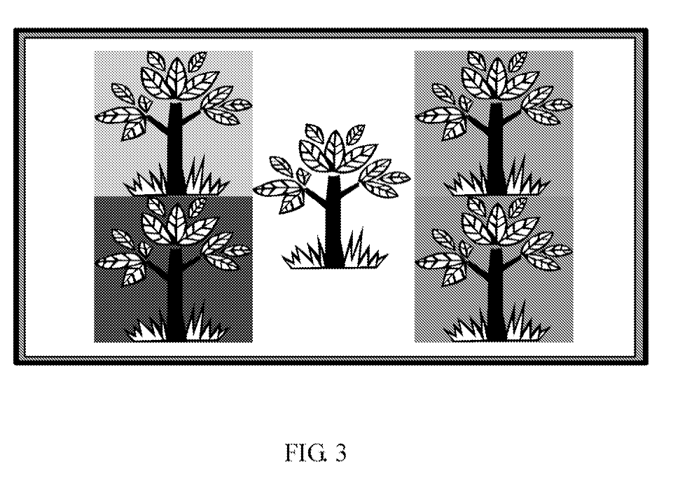

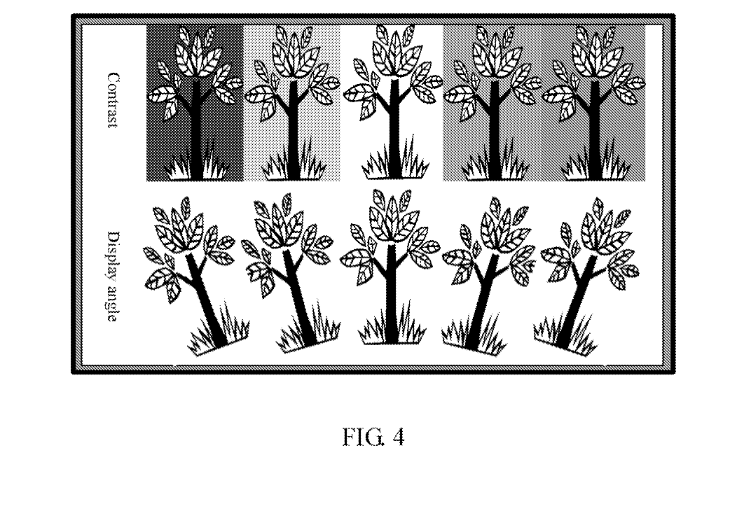

The processor 12, being connected to the memory 13 and the user input unit 11, includes a reading module 121 and a display module 122. The reading module 121 is configured for obtaining images, original property settings, and the predetermined algorithm from the memory 13. When adjusting an image, the display module 122 is configured to retrieve other property settings according to the obtained predetermined algorithm and the obtained original property settings, and displays several instances of the same image at different retrieved settings simultaneously. In the first exemplary embodiment, the display module 122 displays different settings of the contrast property of the image (see FIG. 3). In the second exemplary embodiment, the display module 122 displays that two property settings are being adjusted, e.g., the contrast property and the display angle property of the image (see FIG. 4).

The display module 122 is further configured for selecting a desirable setting of the image from the different settings in response to the user input operation. Additionally, if there is another image property to be adjusted, the display module 122 displays different settings of the to-be-adjusted image property based on the user selected setting for the selection. Once all image properties have been adjusted, the final selected setting of the image becomes the desired setting.

For the purpose of easily understanding the present disclosure, two exemplary processes of adjusting an image are described in following embodiment.

In the first exemplary embodiment, when performing an image adjustment, the display module 122 retrieves 4 property settings according to the predetermined algorithm and the original property settings, that is, contrast values of 40%, 45%, 55%, and 60% are retrieved, together with the original contrast 50%, then, the display modules 122 displays settings of contrast of 40%, 45%, 50% (the original contrast setting), 55%, and 60% simultaneously, so different settings of the image property can be easily compared with each other, see FIG. 3. Therefore, the user can quickly select a preferred setting, for example, setting of 45%. If there are still other image properties to be adjusted according to the predetermined sequence, for example, brightness property, the display module 122 displays different settings of the brightness property based on previous adjustment results. After all image properties of the image are adjusted, the settings of the image properties of the adjusted image are the desirable settings.

In the second exemplary embodiment, when performing an image adjustment, the display module 122 retrieves 4 property settings of contrast, and 4 property settings of display angle according to the predetermined algorithm and the original property settings (e.g., contrast 50%, and display angle 90 degrees), that is, contrasts of 40%, 45%, 55%, and 60% are retrieved, and display angles of rotating left 9 degrees, rotating left 4.5 degrees, rotating right 4.5 degrees, and rotating right 9 degrees are retrieved, then the display module 122 displays different settings of the contrast property and display angle property simultaneously in the display 14 in accordance with the retrieved contrast settings and display angle settings, for example, settings of the contrast include setting of 40%, setting of 45%, setting of 50% (the original property setting), setting of 55%, and setting of 60%, see FIG. 4. User can select any one of the image properties setting being displayed on the display 14, for example, setting of contrast 45%. After contrast property and display angle are adjusted, if there are other image properties to be adjusted, the display module 122 will display different settings of the to-be-adjusted properties. After all image properties are adjusted, the final selected setting will be the desirable setting.

The digital photo frame 10 can also provide a menu item for activating the digital photo frame 10 to enter the property adjustment mode as described above.

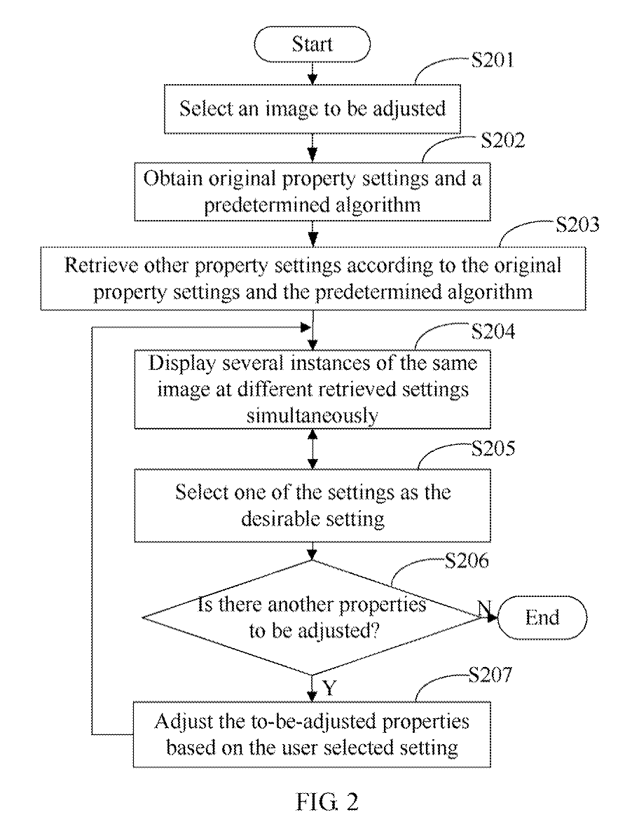

FIG. 2 is a flowchart illustrating a method of adjusting properties of an image implemented by the digital photo frame 10 of FIG. 1 in accordance with an exemplary embodiment.

In step S201, after the property adjustment mode is invoked in the digital photo frame 10 in response to a selection on a corresponding menu item, the user selects a currently displayed image to be adjusted.

In step S202, the reading module 121 obtains original property settings of the selected image and a predetermined algorithm from the memory 13.

In step S203, the display module 122 retrieves different property settings of at least one image property according to the original property the image property and the predetermined algorithm.

In step S204, the display module 122 displays several instances of the same image at different retrieved settings simultaneously.

In step S205, the display module 122 selects one of the settings as the desirable setting in response to the user input operation.

In step S206, the display module 122 determines whether there is still to-be-adjusted properties, if no, the settings of the image are the desirable settings, and the procedure ends.

In step S207, if there is still to-be-adjusted properties, the display module 122 adjusts the to-be-adjusted properties, and the procedure returns to step S203.

Additionally, when adjusting one of the image properties, the display module 122 displays information of the image property, wherein the information may include, but is not limited to, a name of the image property, value of each setting of the image property of the image. The display module 142 can also display the name of the next image property to be adjusted.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A digital photo frame comprising:
a user input unit for receiving user input operations;
a memory for storing images, original image property settings, and a predetermined algorithm, the predetermined algorithm records a rule to retrieve other settings based on an original property setting;
a display for displaying images; and
a processor, being connected to the memory as well as the user input unit and the display, for adjusting images, the processor comprising:
a reading module for obtaining images and original property settings of at least one image property from the memory; and
a display module for retrieving other property settings according to the corresponding original property setting and the predetermined algorithm, displaying several instances of the same image at different retrieved settings simultaneously, and further for selecting one of the settings as the desirable setting in response to the user input operation.

2. The digital photo frame as described in claim 1, wherein the display module displays different settings of another to-be-adjusted properties based on setting of an image property that has been adjusted.

3. The digital photo frame as described in claim 1, wherein the memory further stores a predetermined sequence for recording an order that image properties of an image to be adjusted.

4. The digital photo frame as described in claim 1, wherein the display module further controls the display to display a name of the image property being adjusted and a value of each setting.

5. A method of adjusting image properties applied on a digital photo frame which includes:
a user input unit;
a memory; and
a display,
the method comprising:
selecting an image to be adjusted;
obtaining original image property settings of the selected image and a predetermined algorithm from the memory;
retrieving other property settings according to the original image property settings and the predetermined algorithm.
displaying several instances of the same image at different retrieved settings simultaneously; and
selecting one of the settings as the desired setting in response to user input operation.

6. The method as described in claim 5, further comprising: if there is still to-be-adjusted properties after an image property has been adjusted, the display module displays different settings of the to-be-adjusted property based on setting of an image property that has been adjusted.

7. The method as described in claim 5, further comprising: storing a predetermined sequence for recording an order of image properties to be adjusted.

8. The method as described in claim 7, further comprising: obtaining the predetermined sequence from the memory, the display module displays an image with different settings of each image property in accordance with the predetermined sequence.

9. The method as described in claim 6, further comprising: while adjusting an image, displaying name of an image property being adjusted and a value of each setting.
